(19) United States
(12) Patent Application Publication
(10) Pub. No.: US 2006/0277818 A1
(43) Pub. Date: Dec. 14, 2006

(54) Rodent exterminating apparatus

(76) Inventor: Sage O. Scherman, Carmel Valley, CA (US)

Correspondence Address: Galasso & Associates, LP, P.O. Box 26503, Austin, TX, 78755-0503, US

(21) Appl. No.: 11/449,987

(22) Filed: Jun. 9, 2006

Related U.S. Application Data
(60) Provisional application No. 60/690,080, filed on Jun. 11, 2005.

(51) Int. Cl. A01M 23/00

(52) U.S. Cl. 43/61

(57) ABSTRACT

A consumable rodent extermination gum comprising the ingredients of at least a gum base, sugar, corn syrup, glycerin, citric acid and extract of opuntia cactus, and expanding polymer. Additionally a mild poison could be added. The consumable rodent extermination gum is placed in or near the dwelling of a rodent, such that the rodent consumes the consumable rodent extermination device. The consumable rodent extermination gum ultimately causes blockage in the digestive tract of the rodent, thereby terminating the rodent.

### PRIORITY UNDER 35 U.S.C. §117(e) & 37 C.F.R. §1.78

This nonprovisional application claims priority based upon the following prior United States provisional patent application entitled: Gopher gum, Application No.: 60/690,080, filed Jun. 11, 2005, in the name of Sage O. Scherman, which is hereby incorporated by reference for all purposes.

### FIELD OF THE INVENTION

The present invention relates to devices for the extermination of rodents, and more specifically but not by way of limitation, to a chewable device to be consumed by a rodent that terminates the rodent by substantially blocking at least a part of the digestive of the rodent.

### BACKGROUND OF THE INVENTION

Burrowing rodents are well know for making underground passageways, referred to as burrows, and holes extending from these burrows to the surface of the ground. Burrowing rodents cause many problems for property owners, farmers and ranchers. Burrowing rodents cause damage to growing crops, lumber and landscapes, and canals and other waterways.

Burrowing rodents being pests and causing such damage has resulted in property owners, ranchers and farmers eradicating the rodents themselves or paying to have the rodents eradicated. Such “rodents” including: prairie dogs, gophers, ground squirrels, mice and rats.

As can be appreciated, the elimination of these rodents is highly desirable. A wide variety of methods to trap or poison rodents have been developed in the past. A most common type of trap used for trapping mice and small rats is in the form of a trigger-released spring trap which smashes the back or neck of the rodent upon release. These traps are reusable, but the removal of the trapped rodent is distasteful to many persons. In addition, spring traps of this type pose a real threat of injury to domestic pets and small children. Consequently, their use is generally restricted to places where such pets and children do not have access.

Another approach which is commonly used to eliminate rodents is to spread poisoned bait in areas which are known to be frequented by the rodents. As with the spring trap, however, the use of poisoned bait must be carefully controlled to prevent access to the bait by small children or pets to prevent serious harm from unwanted contact with the poisons.

Other efforts to trap and kill undesirable rodents have led to the use of reusable traps having a sealed chamber which closes upon entry of the rodent into the trap to thereafter suffocate the rodent. After the suffocation is complete, the rodent may be removed from the trap and it then may be reused. While traps of this type do not create any health hazard to pets or children, the relative complexity of the trap and, again, the necessity of removing the rodent from it for reuse has significantly limited the commercial application and use of such traps.

In recent years, various types of tacky resins which retain a fairly consistent degree of tackiness over a long storage period have been employed in the development of rodent and insect traps with a fairly high degree of success. Such traps, when employed as rodent traps, generally utilize a layer of the tacky glue-like resin on the floor of the trap, with some provision for enticing the rodent into the trap. Once the rodent steps onto the tacky glue-like material, it becomes entrapped in it and subsequently dies. The entire trap then may be disposed of or a provision is sometimes made for simply removing the floor of the trap containing the glue-like resin and the entrapped rodent from the trap. A new floor then is put in place for reuse of the trap.

In its simplest form, a sticky glue trap comprises an open tray with the glue-like material placed in it. A trap of this type then is placed along a wall or baseboard in an area known to be frequented by mice or rats. During the night when the mice or rats are running along the wall, they run onto the surface of the trap and become caught. They die within a short period of time and the trap containing the rodent then may be disposed. As with many of the other traps mentioned above, the disposal is often quite unpleasant; because the dead rodent is in full view during the disposal of the trap and rodent.

In view of the foregoing, it is desirable to employ the concept of an inexpensive consumable rodent termination device, which overcomes the disadvantages of the existing devices mentioned above.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of a single unit of an embodiment of the present invention;

FIG. 2 is sectional view taken along line A-A of FIG. 1 of an embodiment of the present invention; and

FIG. 3 is a perspective view of an embodiment of a package containing multiple units of the present invention.

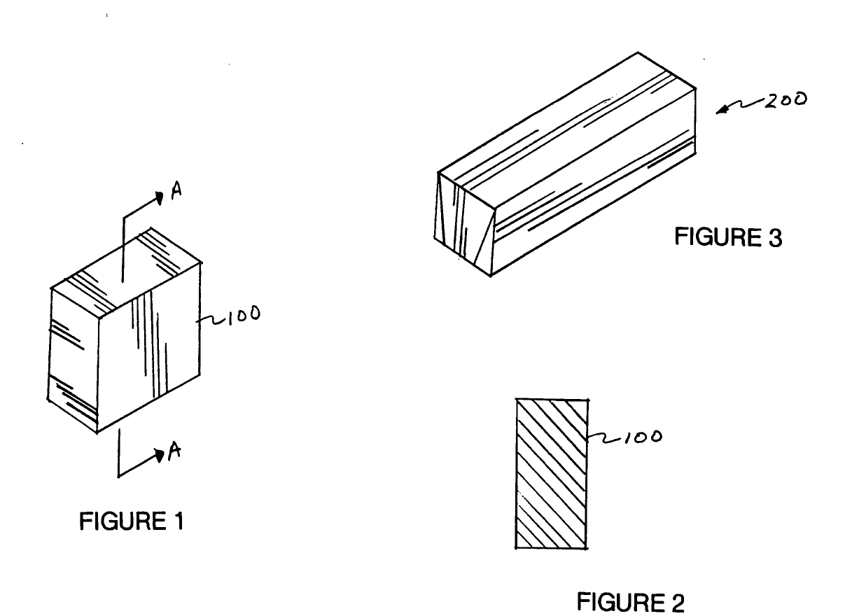

### DETAILED DESCRIPTION

Now referring to the drawings submitted herewith, wherein the various elements depicted therein are not necessarily drawn to scale and wherein like reference numerals are used for like elements throughout the figures and in particular there is illustrated a consumable rodent extermination device 100 according to the principles of the present invention.

In one preferred embodiment consumable rodent extermination device 100 is a type of chewing gum product that includes a gum base, powdered sugar, corn syrup, glycerin, citric acid, extract from Opuntia Cactus (Prickly Pear), and expanding polymer. It is contemplated to be within the scope of this invention that either in lieu of or in addition to the above listed ingredients, various blends of herbs and/or fruit flavors could be utilized in the making of consumable rodent extermination device 100 to configured consumable rodent extermination device 100 for a particular target rodent.

In a second preferred embodiment consumable rodent extermination device 100 is a type of chewing gum product that includes a gum base, powdered sugar, corn syrup, glycerin, citric acid, extract from Opuntia Cactus (Prickly Pear), expanding polymer, and a mild dose of rodent poison. The mild dose of rodent poison is used to increase the speed of the lethal result of consumable rodent extermination device 100. It is contemplated to be within the scope of this invention that, in this embodiment, either in lieu of or in addition to the above listed ingredients, various blends of herbs and/or fruit flavors could be utilized in the making of consumable rodent extermination device 100 to configured consumable rodent extermination device 100 for a particular targeted rodent. Good results have been achieved by using this embodiment for commercial use.

In manufacturing the embodiments disclosed herein, normal chewing gum methods are utilized for the production of consumable rodent extermination device 100.

Good results have been achieved by shaping each piece of consumable rodent extermination device 100 to resemble that of traditional chewing gum with each piece being a solid piece (See FIG. 2), although it is contemplate that various sizes and shapes could be utilized. Each piece of consumable rodent extermination device 100 would be individually wrapped in a foil type paper.

Additionally, good results have been achieved by packaging consumable rodent extermination device 100 in a package 200 that is of size and shape to contain five pieces of consumable rodent extermination device 100 therein (See FIG. 3).

Although good results have been achieved by utilizing consumable rodent extermination device 100 in the termination of gophers, it is contemplated that consumable rodent extermination device 100 could be utilized for virtually any type of rodent or pest, such as but not limited to, mice, rats, and squirrels. It is also contemplated, that the size, shape and contents of consumable rodent extermination device 100 can be varied base upon the type of rodent a particular user may be targeting.

In operation, at least one piece of consumable rodent extermination device 100 is removed from the package 200 and unwrapped. The consumable rodent extermination device 100 is then placed proximate to the residence of a rodent, such as in a hole for a gopher. The rodent, then consumes the consumable rodent extermination device 100. Subsequent to the consumption of consumable rodent extermination device 100, blockage of at least a portion of the digestive track occurs in the rodent. The blockage is substantial enough to terminate the rodent that consumed the consumable rodent extermination device 100.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A consumable rodent extermination device comprising the ingredients of:
at least a gum base, sugar, corn syrup, glycerin, citric acid, and extract of opuntia cactus, each being processed together.

2. The consumable rodent extermination device as recited in claim 1 and further including poison being processed therewith.

3. The consumable rodent extermination device as recited in claim 1 and further including fruit flavoring being processed therewith.

4. The consumable rodent extermination device as recited in claim 2 and further including fruit flavoring being processed therewith.

5. The consumable rodent extermination device as recited in claim 1 wherein each of the ingredients are processed together to form a piece of gum.

6. The consumable rodent extermination device as recited in claim 2 wherein each of the ingredients are processed together to form a piece of gum.

7. A consumable rodent gum composition extermination device comprising:
at least (a) a gum base, (b) sugar, (c) corn syrup, (d) glycerin, (e) citric acid, and (f) extract of opuntia cactus.

8. The consumable rodent gum composition extermination device as recited in claim 7 and further including poison.

9. The consumable rodent gum composition extermination device as recited in claim 7 and further including fruit flavoring.

10. The consumable rodent gum composition extermination device as recited in claim 8 and further including fruit flavoring.

11. The consumable rodent gum composition extermination device as recited in claim 7 wherein the composition is processed into a piece of gum.

12. The consumable rodent gum composition extermination device as recited in claim 8 wherein the composition is processed into a piece of gum.

13. A gum composition to be consumed by rodents, comprising:
at least (a) a gum base, (b) sugar, (c) corn syrup, (d) glycerin, (e) citric acid, and (f) extract of opuntia cactus.

14. The gum composition as recited in claim 13 and further including poison.

15. The gum composition as recited in claim 13 and further including fruit flavoring.

16. The gum composition as recited in claim 14 and further including fruit flavoring.

17. The gum composition as recited in claim 13 wherein the composition is processed into a piece of gum.

18. The gum composition as recited in claim 14 wherein the composition is processed into a piece of gum.

19. The gum composition as recited in claim 13 and further including an expandable polymer.

20. The gum composition as recited in claim 14 and further including an expandable polymer.
